(19) United States
(12) Patent Application Publication
(10) Pub. No.: US 2014/0096842 A1
(43) Pub. Date: Apr. 10, 2014

(54) CIRCULAR SHOWER MACHINE

(71) Applicant: Tsai-Fang Wang, Taipei (TW)

(72) Inventor: Tsai-Fang Wang, Taipei (TW)

(21) Appl. No.: 13/645,509

(22) Filed: Oct. 4, 2012

(51) Int. Cl. F16L 53/00

(52) U.S. Cl. 137/334

(57) ABSTRACT

Most of modern people take a shower with hot water when cleaning the body, indeed, that would be an enjoyment, especially in winter or chilling weather, people keep showering after cleaning body, thus, cause the waste of water and heating energy, thus, present invention provides a shower machine that can keep heating water by circular of heated water, comprises: an electrical water heater which can keep heating water circularly, characterized in: Said electrical water heater is assembled by a shell, a heating device with a water outlet tube which is disposed in said shell, a water feedback tube which is disposed aside the heating device, a water pump with a water inlet tube which is disposed aside the heating device, and a water tube for transporting water to said heating device, which is disposed aside the water pump.

### FIELD OF THE INVENTION

Present invention relates to a circular shower machine.

### BACKGROUND OF THE INVENTION

Most of modern people take a shower with hot water when cleaning the body, indeed, that would be an enjoyment, especially in winter or chilling weather, people keep showering after cleaning body, thus, cause the waste of water and heating energy.

Normal sauna or swimming pool with SPA facilities comprise specific water circular and filtering system, however, needs long time and large investment to plan and build, most of people do not build the system and SPA facilities in their own house due to limited space of bathing room, and also cannot afford it.

Thus, to provide a circular shower machine that can keep heating water by circular loop of heated water, therefore, save energy and reduce carbon exhausting, have become the main issue of present invention.

### SUMMARY OF PRESENT INVENTION

To achieve aforementioned object, present invention provides a shower machine that can keep heating water by circular of heated water, comprises:

An electrical water heater which can keep heating water circularly, characterized in:

Said electrical water heater is assembled by

A shell;

A heating device with a water outlet tube which is disposed in said shell;

A water feedback tube which is disposed aside the heating device.

A water pump with a water inlet tube which is disposed aside the heating device; and

A water tube for transporting water to said heating device, which is disposed aside the water pump.

Another embodiment of present invention provides a shower machine that can keep heating water by circular loop of heated water, comprises:

An electrical water heater which can keep heating water circularly, characterized in:

Said electrical water heater is assembled by

A shell;

A heating device with a water outlet tube which is disposed in said shell;

A first water inlet tube which is disposed aside the heating device.

A water pump with a second water inlet tube which is disposed aside the heating device; and

A water tube for transporting water to said heating device, which is disposed aside the water pump.

Said water outlet tube can be connected with one or both of following device (s):

controlling valve, water outlet device.

Said water heater is one of following:

electrical water heater, gas water heater, heat pump water heater, solar water heater.

The water heater further comprises a control device which can switch on or off the water heating device and water pump.

An electrical and magnetic valve is disposed aside the heating device.

### BRIEF DESCRIPTION OF THE DRAWINGS

FIG. 1 is perspective view of the 1^{st} embodiment of present invention.

FIG. 2 is vertical cross section view of 1^{st} embodiment of present invention.

FIG. 3 is scheme of practicing of 1^{st} embodiment of present invention.

FIGS. 4, 5 are action illustrations for practicing of 1st embodiment of present invention.

FIG. 6 is perspective view of the 2^{nd} embodiment of present invention.

FIG. 7 is vertical cross section view of 2^{nd} embodiment of present invention.

FIG. 8 is scheme of practicing of 2^{nd} embodiment of present invention.

FIGS. 9 and 10 are action illustrations for practicing of 2^{nd} embodiment of present invention.

### DETAILED DESCRIPTION OF PRESENT INVENTION

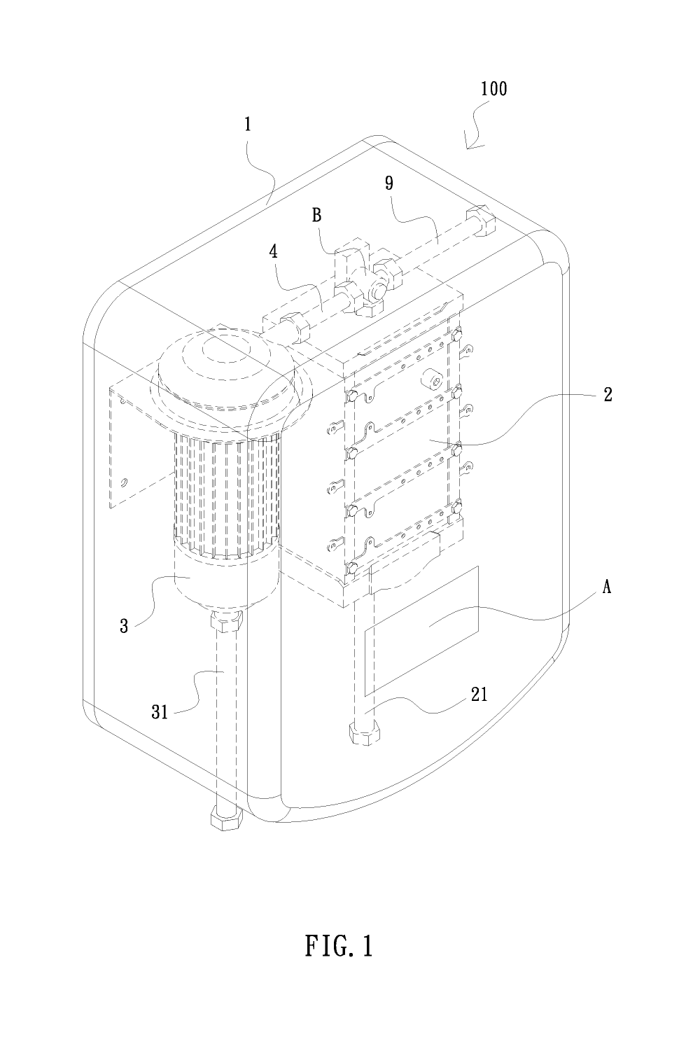

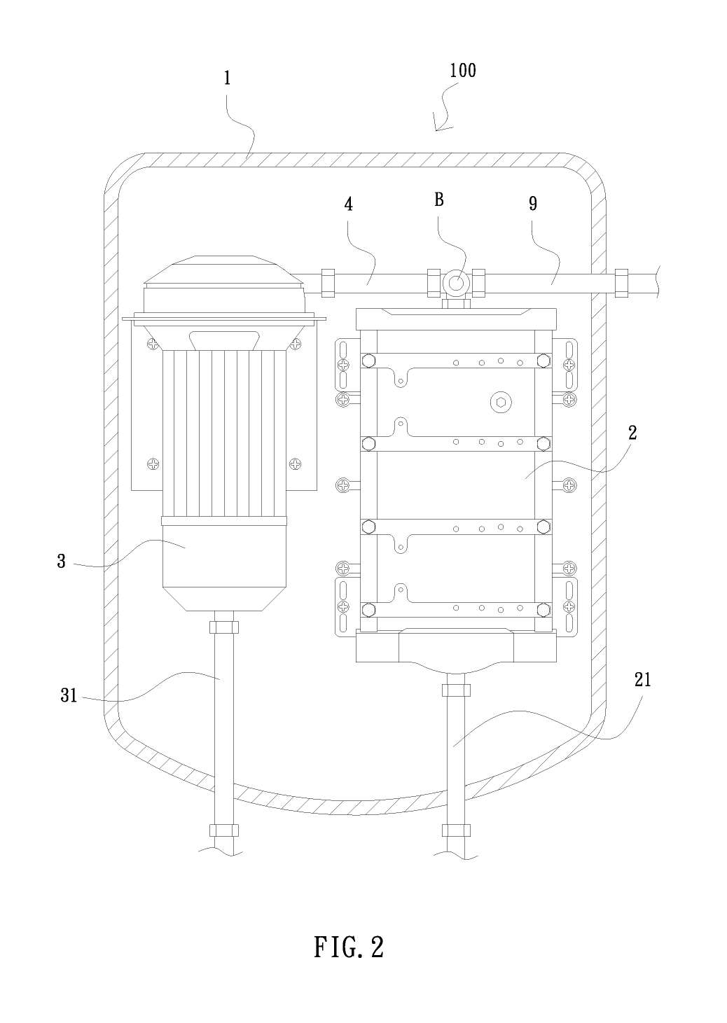

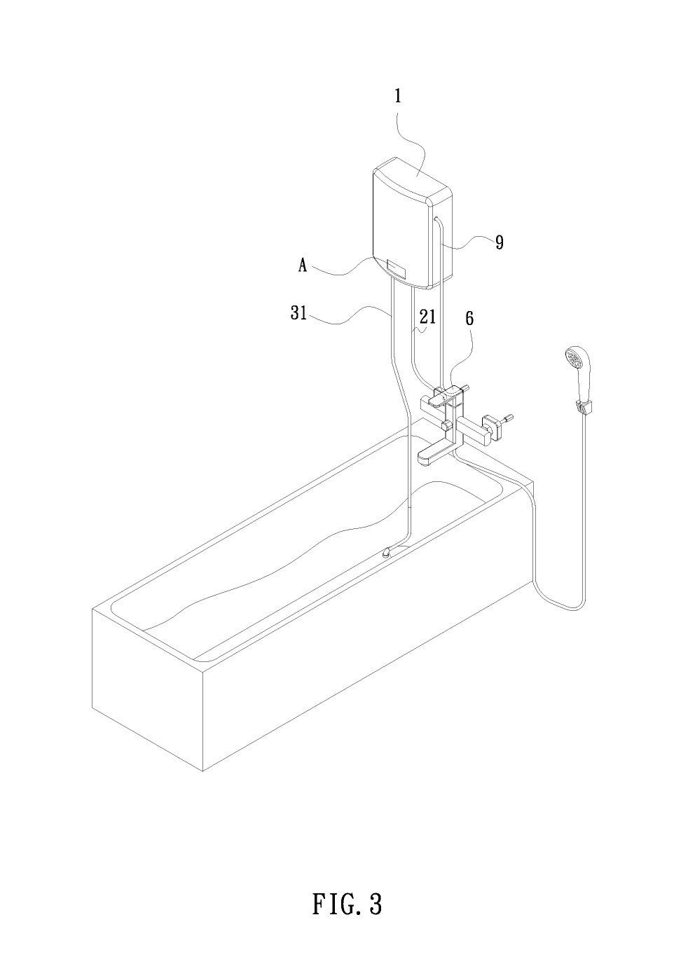

The 1^{st} embodiment of present invention reveals a shower machine as FIGS. 1 to 5 shown, which comprises:

An electrical water heater 100 which can keep heating water circularly, characterized in:

Said electrical water heater is assembled by

A shell 1;

A heating device 2 with a water outlet tube 21 which is disposed in said shell 1;

A water feedback tube 9 which is disposed aside the heating device 2.

A water pump 3 with a water inlet 31 tube which is disposed aside the heating device 2; and

A water tube 4 for transporting water to said heating device 2, which is disposed aside the water pump 3.

Said electrical water heater 100 further comprises a control device A which can switch on or off said heating device 2 and water pump 3.

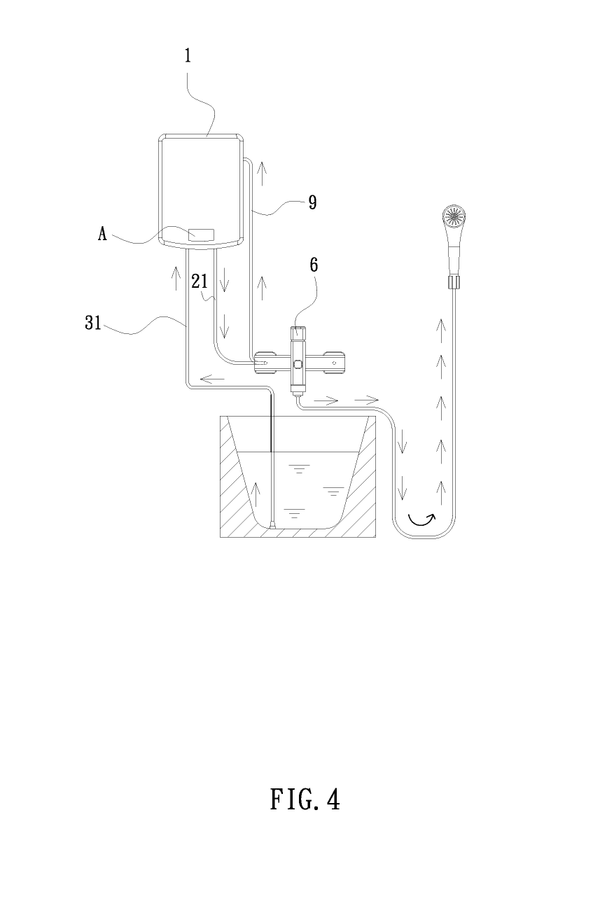

As FIG. 4 shown, when control device A switches on, the water in the bath tub is drawn up through the water inlet tube 31 to the shower electrical water heater 100 by the water pump 3(not shown in FIG. 4), and heated by heating device 2(not shown in FIG. 4), than be exhausted through the water outlet tube 21 to the water sprayer through the water outlet device 6, in the meanwhile, parts of heated water from the water outlet tube 21 would also be drawn up through the water feedback tube 9 to the electrical water heater 100(not shown in FIG. 4), and release the latent heat to the unheated water from the bath tub, thus, the water from the bath tub is circular heated, and heating device 2 consumes less energy to heat the unheated water.

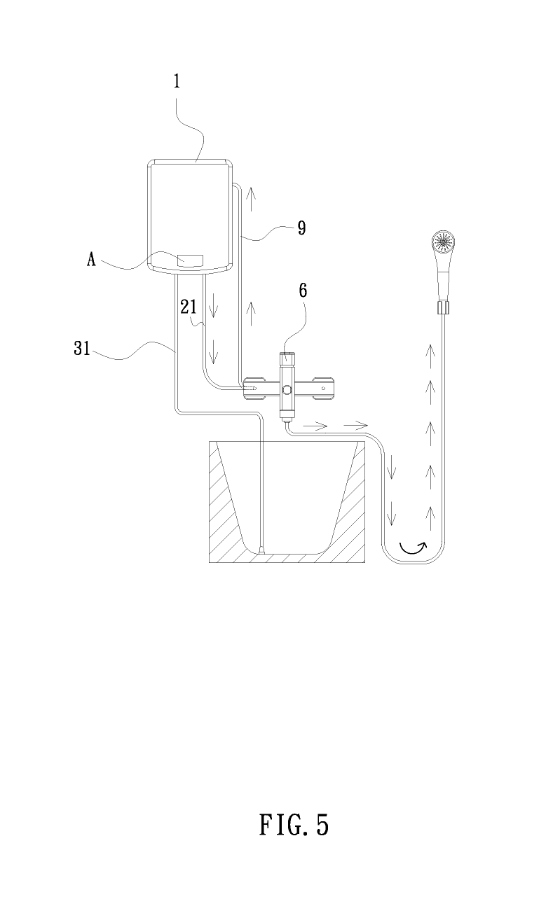

As FIG. 5 shown, if the bath tub is empty, the water from the water source would flow through the water outlet device 6, and be drawn up through the water feedback tube 9 to the electrical water heater 100(not shown in FIG. 4), be heated by the heating device 2(not shown in FIG. 4), than be exhausted through the water outlet tube 21 to the water outlet device 6, in the meanwhile, parts of heated water from the water outlet tube 21 would also be drawn up through the water feedback tube 9 to the electrical water heater 100(not shown in FIG. 5), and release the latent heat to the unheated water, thus, the water from water source is circular heated, and heating device 2 consumes less energy to heat the unheated water.

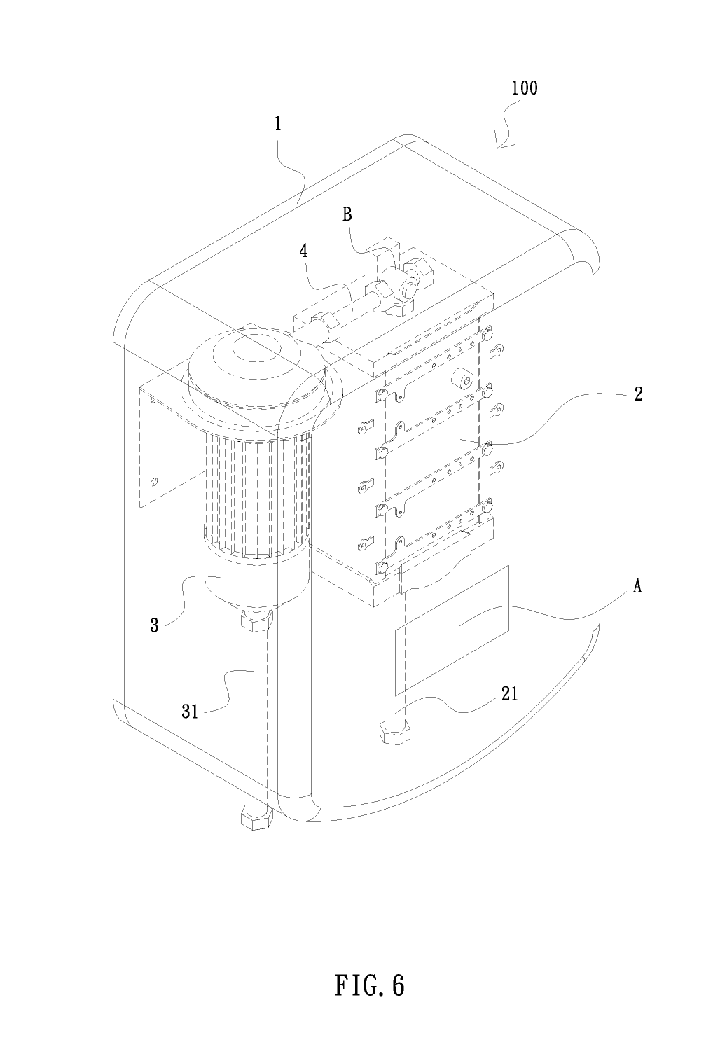

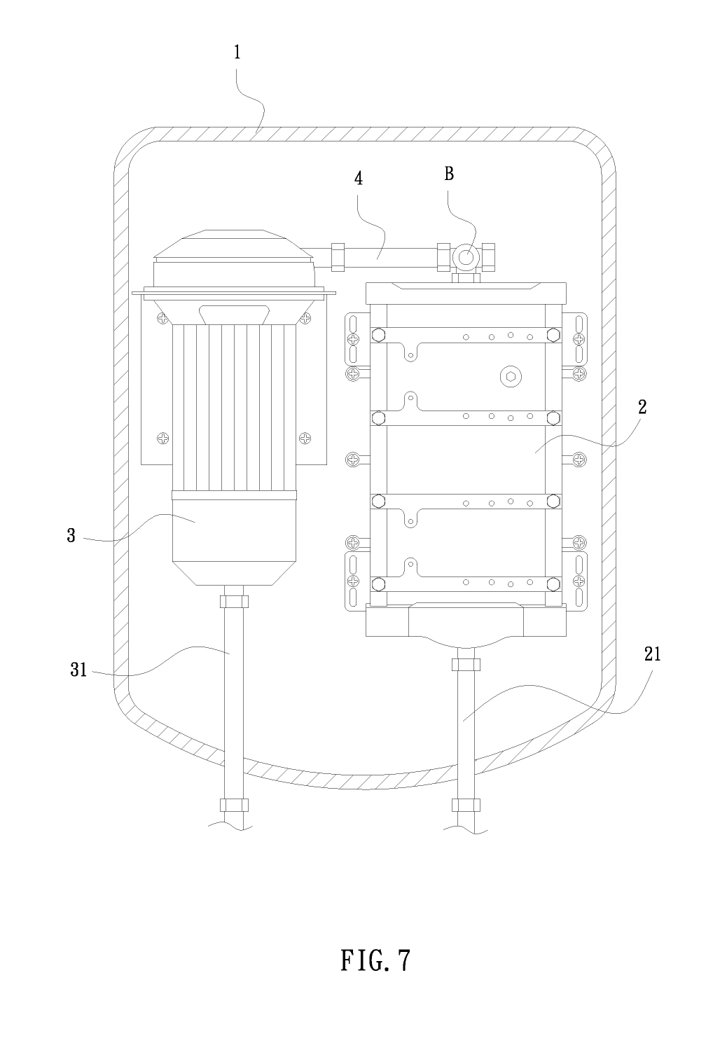

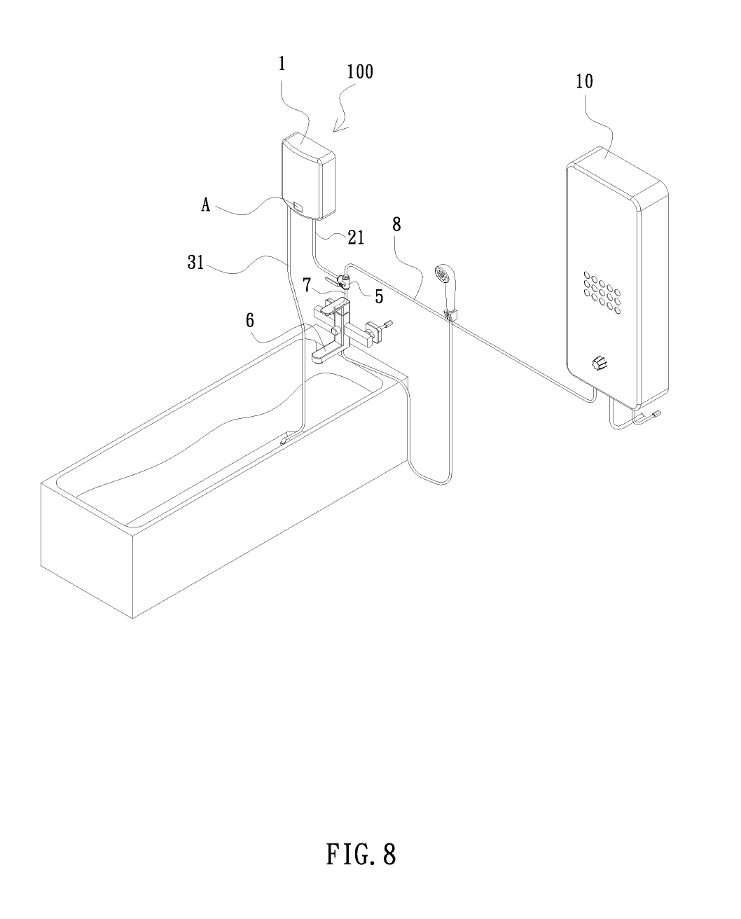

The 2^{nd} embodiment of present invention reveals a shower machine as FIGS. 6 to 10 shown, which comprises:

An electrical water heater 100 which can keep heating water circularly, characterized in:

Said electrical water heater 100 is assembled by

A shell 1;

A heating device 2 with a water outlet tube 21 which is disposed in said shell 1;

A water pump 3 with a second water inlet tube 31 which is disposed aside the heating device 2; and

A water tube 4 for transporting water to said heating device 2, which is disposed aside the water pump 3.

Present invention is capable of heating water circularly by applying and co-working of said heating device 2 and water pump 3.

Said water outlet tube 21 can be connected to one or both of following device (s):

controlling valve 5, water outlet device 6.

Said electrical water heater 100 further comprises a control device A which can switch on or off said heating device 2 and water pump 3.

Present invention can be used easily due to the application of said control device A.

Furthermore, an electrical and magnetic valve B which is for controlling the direction of water flowing, is disposed aside the heating device 2.

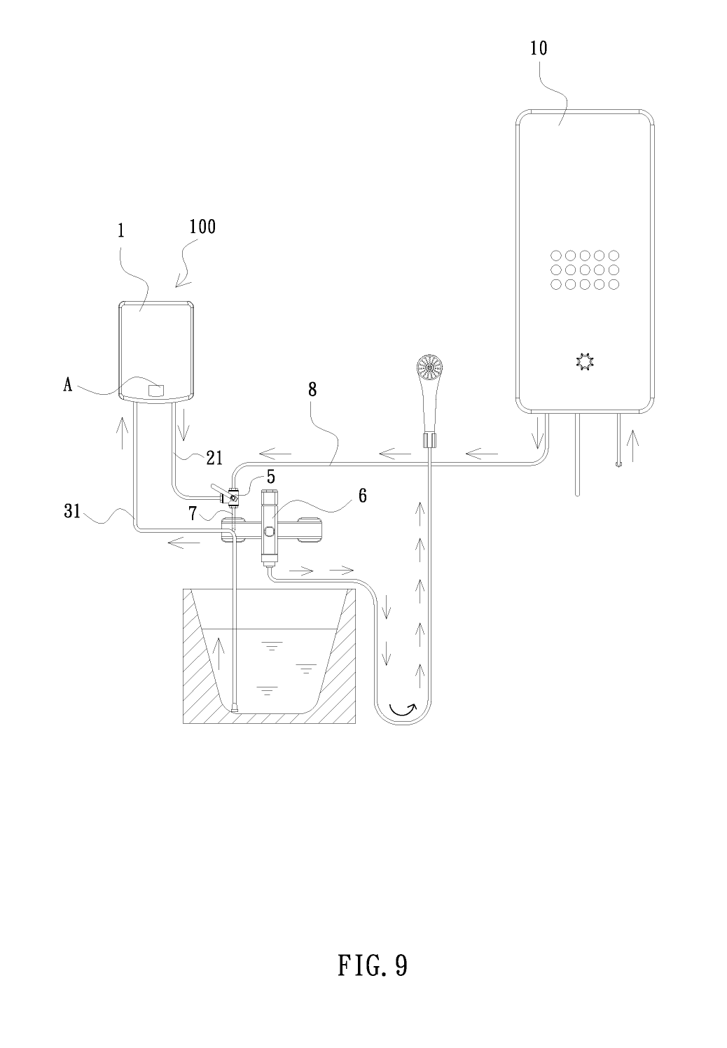

As FIG. 9 shown, when control device A switches on, the water in the bath tub is drawn up through the water inlet tube 31 to the shower electrical water heater 100 by the water pump 3(not shown in FIG. 9), and heated by heating device 2(not shown in FIG. 9), than be exhausted through the water outlet tube 21 to the controlling valve 5, when said controlling valve 5 is opened, the heated water from the bath tub goes through the water tube 7 to the water outlet device 6, in the meanwhile, the water from local water source is heated by the water heater 10, flows through the water guiding tube 8 and said water tube 7, and mixes with the heated water from the bath tub, than flow to the water sprayer through the water outlet device 6, thus, the water heater 10 and heating device 2 of present invention both consume less energy for heating water, this embodiment of present invention can also operate independently when the water heater 10 is broken or switched off due to its own heating device 2.

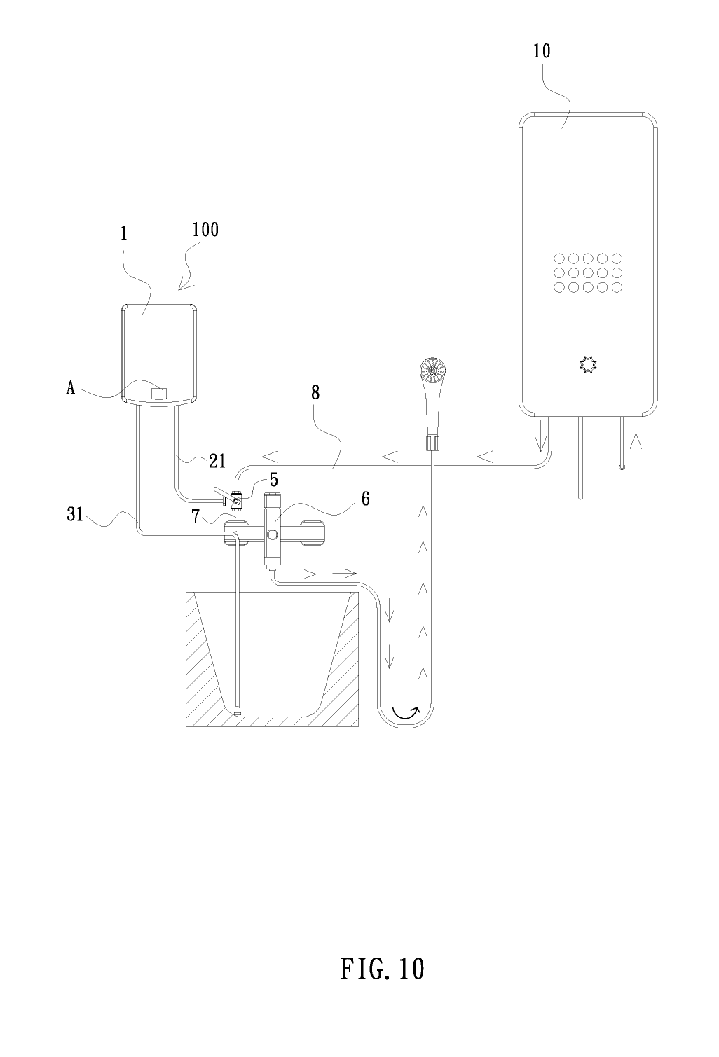

As FIG. 10 shown, when the bath tub is empty, the control device A can be switched off to seize the shower machine, and the water can be heated and supplied by the water heater 10.

According to above description, this embodiment of present invention not only can save energy, but also has more flexibility of using and be more dependable.

The advantages of present invention compare to conventional art, which are as following:
1. Present invention can be applied with conventional water heater, thus, has more ways of deploying, and becomes more dependable.
2. Present invention can operate independently without connecting with the water heater, thus, the installation of present invention can be easier depends on the need of user.
3. Present invention can save energy of heating by mixing the hot water from outside or circularly heating water, and user of present invention can choose the way of deploying to fulfill the need of saving energy according to present living condition.

Present invention includes but not limited to the illustrative embodiments herein, alternatives of designs and uses would apparently use the skills described, thus, the practice or use of present invention shall be included and limited as what is claimed hereafter.

1. A shower machine that can keep heating water by circular of heated water, comprises:
An electrical water heater which can keep heating water circularly, characterized in:
Said electrical water heater is assembled by
A shell;
A heating device with a water outlet tube which is disposed in said shell;
A water feedback tube which is disposed aside the heating device;
A water pump with a water inlet tube which is disposed aside the heating device; and
A water tube for transporting water to said heating device, which is disposed aside the water pump.

2. A shower machine of claim 1, wherein one end of said water outlet tube is connected with a controlling valve, said controlling valve is connected with a water tube which is connected to a water outlet device, and a water guiding tube which is connected to a water heater.

3. A shower machine of claim 1, wherein said electrical water heater comprises a control device which can switch on or off said heating device and water pump.

4. A shower machine of claim 2, wherein said water heater is one of following:
electrical water heater, gas water heater, heat pump water heater, solar water heater.

5. A shower machine that can keep heating water by circular of heated water, comprises:
An electrical water heater which can keep heating water circularly, characterized in:
Said electrical water heater is assembled by
A shell;
A heating device with a water outlet tube which is disposed in said shell;
A water pump with a water inlet tube which is disposed aside the heating device; and
A water tube for transporting water to said heating device, which is disposed aside the water pump.

6. A shower machine of claim 5, wherein one end of said water outlet tube is connected to the water outlet device.

7. A shower machine of claim 5, wherein said electrical water heater further comprises a control device which can switch on or off said heating device and water pump.

8. A shower machine of claim 5, wherein an electrical and magnetic valve which is for controlling the direction of water flowing, is disposed aside said heating device 2.
